(19) United States
(12) Patent Application Publication
(10) Pub. No.: US 2007/0300086 A1
(43) Pub. Date: Dec. 27, 2007

(54) Processor core wear leveling in a multi-core platform

(76) Inventors: Robert F. Kwasnick, Palo Alto, CA (US); Padmashree K. Apparao, Portland, OR (US); Paul F. Newman, Hillsboro, OR (US)

Correspondence Address: Buckley, Maschoff & Talwalkar LLC;Attorney for INTEL Corporation, Five Elm Street, New Canaan, CT, 06840, US

(21) Appl. No.: 11/476,191

(22) Filed: Jun. 27, 2006

(51) Int. Cl. G06F 1/00

(52) U.S. Cl. 713/300

(57) ABSTRACT

A system may comprise a first processor core, a second processor core and a processor core scheduler. The first processor core may include a first circuit to generate a first data and a second processor core may include a second circuit to generate a second data. The processor core scheduler may assign a first thread to the first processor core or to the second processor core based on the first data and the second data.

### BACKGROUND

A multi-core platform includes two or more processor cores. Such a platform may allocate tasks to its processor cores based on any number of conventional algorithms. Over time, as the platform is used, each processor core may age or wear differently than the other processor cores of the platform.

Uneven wear or aging of processor cores may reduce an expected lifetime of the multi-core platform. More particularly, the useful lifetime of the platform is governed by its least-reliable processor core. If one processor core exhibits significantly more wear than other processor cores of the platform, the useful lifetime may be prematurely shortened.

### BRIEF DESCRIPTION OF THE DRAWINGS

FIG. 1 illustrates a system according to some embodiments.

FIG. 2 comprises a flow diagram of a process according to some embodiments.

FIG. 3 illustrates a system according to some embodiments.

FIG. 4 illustrates a system according to some embodiments.

FIG. 5 is tabular representation of a portion of a database according to some embodiments.

FIG. 6 is tabular representation of a portion of a database according to some embodiments.

FIG. 7 comprises a flow diagram of a process according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

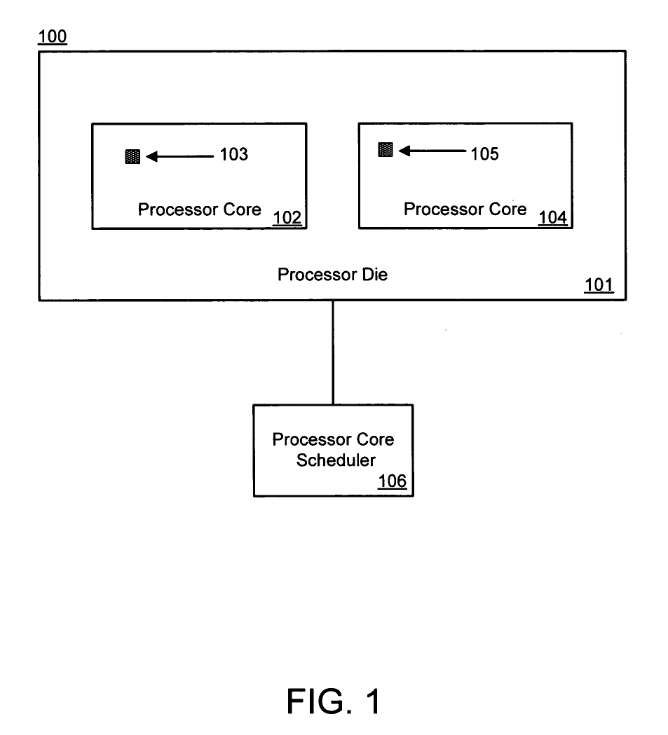

Referring to FIG. 1, an embodiment of a system 100 is shown. The system 100 may comprise a processor die 101 and a processor core scheduler 106. In some embodiments, the processor die may include the processor core scheduler 106. The processor die 101 includes a first processor core 102 and a second processor core 104. The system 100 may comprise any electronic system, including, but not limited to, a desktop computer, a server, and a laptop computer. Moreover, the processor die 101 may comprise any integrated circuit die that is or becomes known.

For purposes of the present description, each of the processor cores 102 and 104 comprise systems for executing program code. The program code may comprise one or more threads of one or more software applications. Each of the processor cores 102 and 104 may include or otherwise be associated with dedicated registers, stacks, queues, etc. that are used to execute program code and/or one or more of these elements may be shared there between.

As illustrated in FIG. 1, the first processor core 102 may comprise a first circuit 103 to generate a first data and the second processor core 104 may comprise a second circuit 105 to generate a second data. The first circuit 103 and the second circuit 104 may comprise elements whose performance degrades with use (e.g. with the application of voltage and temperature stress). Degradation of the circuit may be caused by temperature stress, which may degrade a transistor current drive over time due to the well-known positive-channel metal-oxide semiconductor bias temperature stress effect. Accordingly, the first data and the second data may indicate this degradation, or wear.

In some embodiments, the first circuit 103 may comprise, but is not limited to, a ring oscillator and the second circuit 105 may comprise, but is not limited to, a ring oscillator. In some embodiments, the first processor core 102 may comprise two or more ring oscillators and the second processor core 104 may comprise two or more ring oscillators. The generated data may comprise a frequency difference or an oscillation frequency associated with a respective ring oscillator according to some embodiments. The nature and usage of such data will be described in detail below.

The processor core scheduler 106 may be implemented in hardware, firmware, or software. In some embodiments, the processor core scheduler 106 may request the data from the first circuit 103 and the second circuit 105 and may receive the data in return. The processor core scheduler 106 may assign a thread to the first processor core 102 or to the second processor core 104 based on the first data and the second data. The foregoing structure may provide even processor core wear and therefore decrease the probability of a system failure over time.

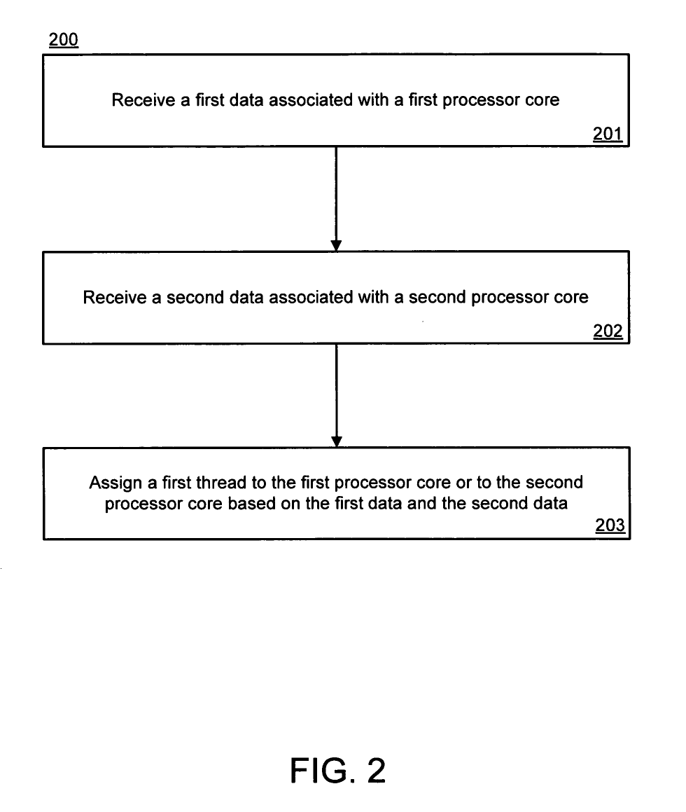

Now referring to FIG. 2, an embodiment of a process 200 is shown. Process 200 may be executed by any combination of hardware, software, and firmware, including but not limited to, the system 100 of FIG. 1. Some embodiments of process 200 may provide leveling of wear across two or more processor cores.

At 201, a first data associated with a first processor core may be received. The first data may indicate wear of the first processor core. According to some embodiments, the first data comprises an oscillation frequency of a ring oscillator disposed in the first processor core.

At 202, a second data associated with a second processor core may be received. The second data may also indicate wear associated with the second processor core. The second data may be received from a second circuit in some embodiments and the second data may comprise an oscillation frequency of the second circuit. As described above, the first processor core and the second processor core may be disposed on a single processor die. In some embodiments, the first processor core and the second processor core are disposed on different processor dies.

Next, at 203, a first thread is assigned to the first processor core or to the second processor core based on the first data and the second data. According to some embodiments of 203, the processor core scheduler 106 assigns the first thread based on wear (or aging) of the first processor core 102 and the second processor core 104. In this regard, the first data and the second data may indicate that the second processor core 104 exhibits greater wear than the first processor core 102. Accordingly, in order to distribute processor core wear evenly throughout the processor die 101, the processor core scheduler 106 may assign the first thread to the first processor core 102 at 203.

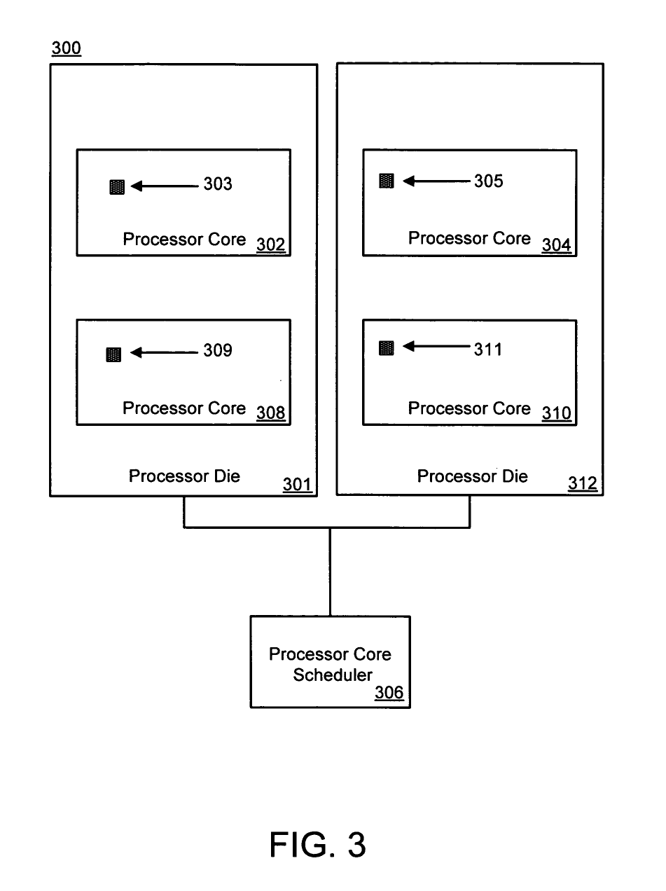

At FIG. 3, an embodiment of a system 300 is shown. The system 300 may implement process 200 according to some embodiments. The system 300 may comprise a first processor die 301, a second processor die 312, and a processor core scheduler 306. The first processor die 301 may include one or more processor cores. As illustrated in FIG. 3, the first processor die 301 includes a first processor core 302 and a second processor core 308, and the second processor die 312 is associated with a third processor core 304 and a fourth processor core 310. The system 300, the illustrated processor die, and the processor cores may comprise any of the implementations described above with respect to identically-named elements of FIG. 1.

Each processor core 302, 304, 308, 310 may comprise a circuit 303, 305, 309, 311, respectively, to generate data. The data may indicate wear of the associated processor cores. Each of circuits 303, 305, 309, 311 may comprise a ring oscillator circuit, with the generated data comprising of an oscillation frequency of the ring oscillator circuit. In some embodiments, the first circuit 303, the second circuit 309, the third circuit 305, and the fourth circuit 311 may each comprise two or more ring oscillator circuits.

The processor core scheduler 306 may be implemented in software, firmware, or hardware. In some embodiments, the processor core scheduler 306 may request the above-mentioned data from each of circuits 303, 305, 309, 311 and may receive the data in return. The processor core scheduler 306 may assign a thread to processor cores 302, 304, 308, 310 based on each core's respective data. In some embodiments, the processor core scheduler 306 may assign a first thread to a processor core 302, 308 associated with the first processor die 301 and may assign a second thread to a processor core 304, 310 associated with the second processor die 312 based on the data.

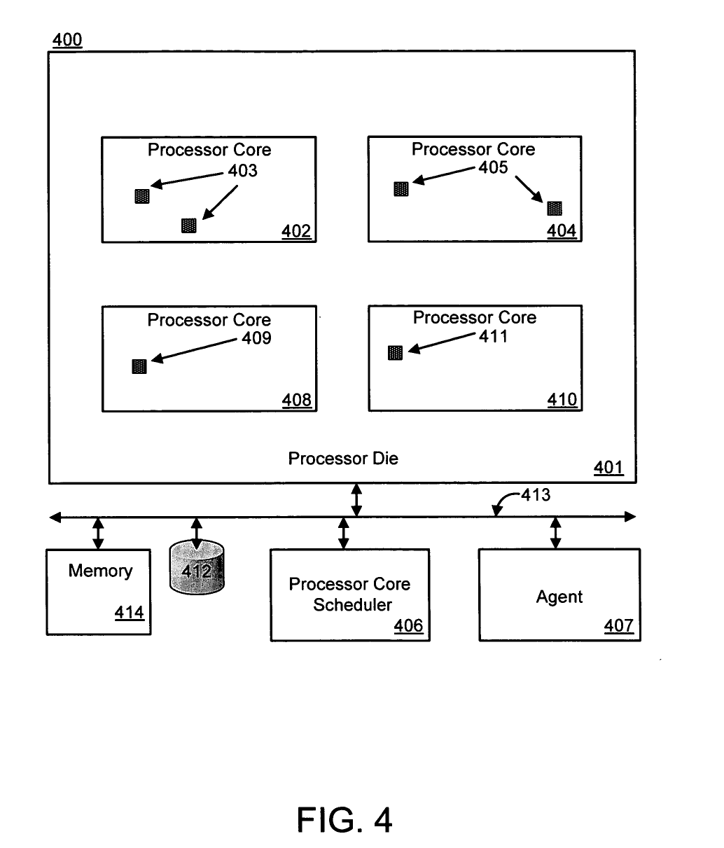

System 400 of FIG. 4 demonstrates an embodiment. The system 400 may also execute process 200 of FIG. 2. The system 400 may comprise a processor die 401, a memory 414, a database 412, a bus 413, an agent 407, and a processor core scheduler 406. The processor die 401 may include one or more processor cores. As illustrated in FIG. 4, the processor die 401 includes a first processor core 402, a second processor core 404, a third processor core 404, and a fourth processor core 410. In some embodiments, the system 400 implements a multi-core server platform.

Each processor core 402, 404, 408, 410 may comprise one or more circuits 403, 405, 409, 411 respectively to generate data. The data may be generated periodically or in response to a request from the processor core scheduler 406, and may be stored in the database 412. As illustrated in FIG. 4, the first processor core 402 may comprise two first circuits 403, the second processor core 308 may comprise a second circuit 409, the third processor core 404 may comprise two third circuits 405, and the fourth processor core 410 may comprise a fourth circuit 411. In some embodiments, the first circuits 403, the second circuit 409, the third circuits 405, and the fourth circuit 411 may each comprise, but are not limited to, one or more ring oscillator circuits. Accordingly, the generated data may relate to an oscillation frequency of a ring oscillator circuit. In some embodiments, one or more ring oscillator circuits may be located within a processor core 402, 404, 408, 410 based on die area, power, accessibility, locations that may exhibit higher temperatures, or in locations that may be otherwise speed limited.

The agent 407 may receive data from each circuit 403, 409, 405, 411 for the above mentioned data. In some embodiments, the agent may assess the degradation and/or classify the wear of each processor core 402, 408, 404, 410 based on the received data. The agent 407 may be implemented in hardware, firmware, or software. Information generated by the agent 407 may be stored in database 412 in association with a respective processor core. In some embodiments, the agent may continuously poll each circuit 403, 409, 405, 411 at predetermined intervals.

The processor core scheduler 406 may be implemented in firmware, hardware, or software. In some embodiments, the processor core scheduler 406 may request the data from each of circuits 403, 405, 409, 411 via the agent 407 and may receive the data in return. The processor core scheduler 406 may assign a thread to processor cores 402, 404, 408, 410 based on each core's respective data. In some embodiments, the processor core scheduler 406 will assign a thread to a processor core 402, 404, 408, 410 only if the data shows that a wear or degradation of the processor core is less than a predetermined percentage.

In some embodiments, the processor core scheduler 406 uses data from both of the circuits 403 to assign a thread to one of the processor cores 403, 404, 408, 410. The processor core scheduler 406 may determine an average of such data in order to facilitate comparison of the processor core 402 with the processor cores 404, 408, 410. In some embodiments, the average may comprise a weighted average based on the location of each circuit 403, 405, 409, 411. For example, a hotter region of a processor core 402, 404, 408, 410 may degrade faster than a cooler region of the processor core 402, 404, 408, 410. Accordingly, data generated by circuits 403, 405, 409, 411 located within known regions of the processor core 402, 404, 408, 410 may be weighted based on the expected relative temperature of their respective regions.

The memory module 414 may store, for example, applications, programs procedures, and/or modules that store instructions to be executed. The memory module 414 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

The database 412 may store data used by the processor core scheduler 406 to assign threads to processor cores 402, 404, 408, 410. In some embodiments, the agent 407 stores the data in the database 412. The database 412, may be comprised of, but not limited to, non-volatile memory, flash memory, magnetic media, optical media, read only memory, or any other available media.

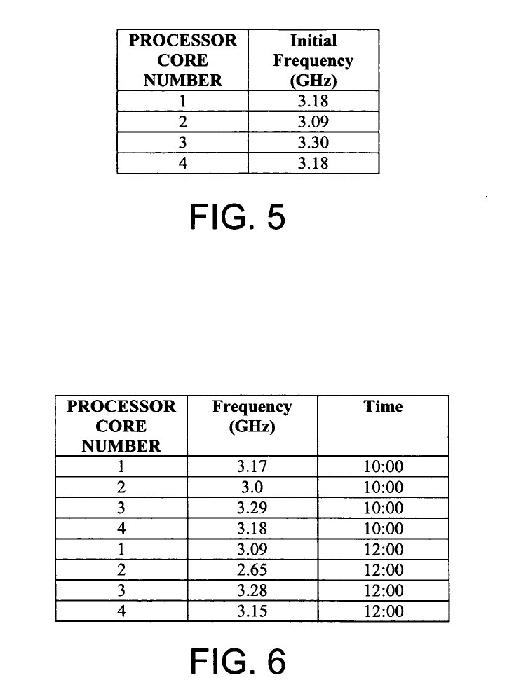

FIG. 5 illustrates a tabular representation of a portion of a database. In some embodiments, the tabular representation associates each of the processor cores 402, 404, 408, 410 with an initial frequency measurement. The initial frequency measurement may reflect an oscillation frequency of respective circuits 403, 405, 409, 411 as described above, the oscillation frequency of circuits 403 and 405 may be represented as an average. In some embodiments, the initial frequency may be automatically determined at a time of fabrication of each processor core and stored in a non-volatile memory. In some embodiments, the initial frequency may be automatically determined by the agent 407 at a first system power up and stored in the database 412.

FIG. 6 is a tabular representation of a portion of a database. FIG. 6 associates each of several processor cores with an oscillation frequency and a time at which the oscillation frequency was measured. The database portion of FIG. 6 may be populated by the agent 407 of the system 400. In some embodiments, the agent 407 receives data periodically from each of circuits 403, 405, 409, 411 and populates the FIG. 6 portion of database 412 with the received data and the time at which the data was received. The initial frequencies and processor core numbers of FIG. 5 and FIG. 6 may be represented by any alphanumeric character, symbol, or combination thereof and may be expressed in any suitable units.

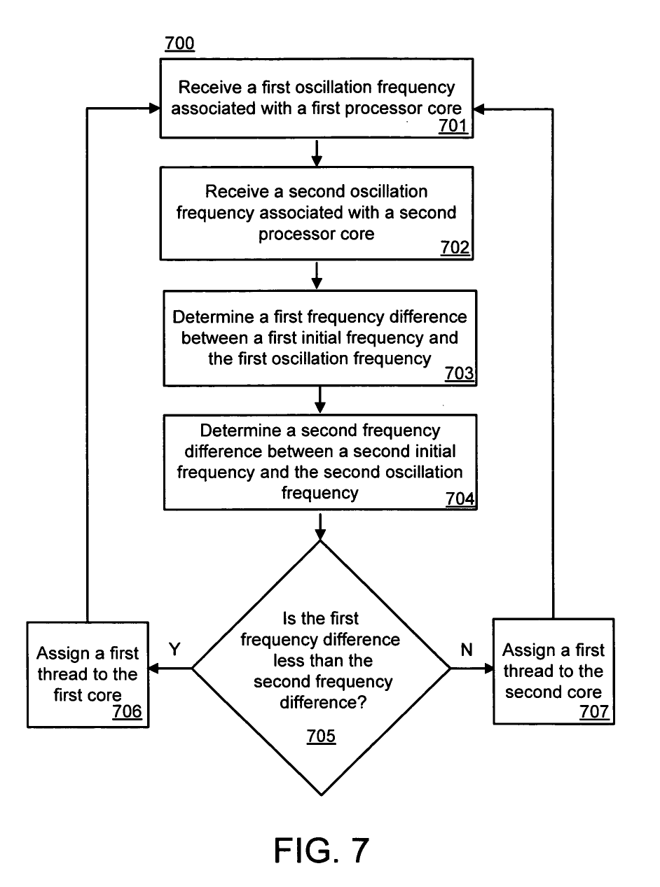

At FIG. 7, an embodiment of a process 700 is shown. At 701, a first oscillation frequency associated with a first processor core may be received. As described with respect to FIG. 4, in some embodiments, the agent 407 may receive a first oscillation frequency from one of circuits 403, 405, 409, 411 at 701. The frequency may be stored in the database 412 as shown in FIG. 6.

Next, at 702, a second oscillation frequency associated with a second processor core may be received. According to some embodiments of 702, the agent 407 receives a second oscillation frequency from another one of circuits 403, 405, 409, 411 at 702, and stores the frequency in the database 412. At 703, a first frequency difference is determined between a first initial frequency and the first oscillation frequency. The first initial frequency may be associated with a same processor core as the first oscillation frequency. In this regard, the first initial frequency may indicate a previous (e.g., at fabrication time) oscillation frequency of a circuit associated with the first processor core. The first initial frequency may be determined from the FIG. 5 data and, in some embodiments, the agent 407 may receive the second oscillation frequency at a system power-up.

At 704, a second frequency difference is determined between a second initial frequency and the second oscillation frequency. Again, the second initial frequency may be determined from the FIG. 5 data and may be associated with a same processor core as the second oscillation frequency received at 702. More specifically, the second initial frequency may indicate a previous oscillation frequency of a circuit associated with the second processor core.

At 705, the first frequency difference is compared to the second frequency difference. The first frequency difference may provide an indication of a degree of wear experienced by the first processor core since determination of the first initial frequency. Similarly, the second frequency difference may provide an indication of a degree of wear experienced by the second processor core since determination of the second initial frequency. In some embodiments, a greater frequency difference indicates a greater amount of wear.

Accordingly, at 706, the processor core scheduler associates a thread with the first processor core if the first frequency difference is less than the second frequency difference. If the first frequency difference is greater than the second frequency difference, then the processor core scheduler may associate the thread with the second processor core at 707. In some embodiments, process 700 may be periodically repeated to assess relative degradation after a large interval, relative to a processor clock cycle, to avoid significant consumption of processor core resources. In between the repeated intervals, threads may be sent to a less degraded core until a next assessment of relative degradation. Some embodiments of process 700 may provide leveling of wear across two or more processor cores. In some embodiments, a usage uniformity of between five and ten percent of each processor core 402, 404, 408, 410 may be obtained.

Various modifications and changes may be made to the foregoing embodiments without departing from the broader spirit and scope set forth in the appended claims.

What is claimed is:

1. A system comprising:
a first processor core comprising a first circuit to generate a first data;
a second processor core comprising a second circuit to generate a second data; and
a processor core scheduler to assign a first thread to the first processor core or to the second processor core based on the first data and the second data.

2. The system of claim 1, wherein the first data is associated with an oscillation frequency of the first circuit and the second data is associated an oscillation frequency of the second circuit.

3. The system of claim 2, wherein the first data comprises a first frequency difference between an initial frequency measurement and the oscillation frequency of the first circuit, and wherein the second data comprises a second frequency difference between a second initial frequency measurement and the oscillation frequency of the second circuit.

4. The system of claim 3, wherein the processor core scheduler is to assign the thread to the first processor core if the first frequency difference is less than the second frequency difference.

5. The system of claim 1, wherein the first data indicates wear of the first processor core and the second data indicates wear of the second processor core.

6. The system of claim 1, wherein the first processor core and the second processor core are disposed within a same die.

7. The system of claim 1, wherein the first circuit comprises a first ring oscillator, and the second circuit comprises a second ring oscillator.

8. The system of claim 7, wherein the first ring oscillator circuit is located within the first processor core based on die area, power, and accessibility and the second ring oscillator circuit is located within the second processor core based on die area, power, and accessibility.

9. The system of claim 1, wherein the first processor core includes a third circuit to generate a third data and the second processor core includes a fourth circuit to generate a fourth data, and wherein the processor core scheduler is to assign a first thread to the first processor core or to the second processor core based on the first data, the second data, the third data and the fourth data.

10. A method comprising:
receiving a first data associated with a first processor core;
receiving a second data associated with a second processor core;
assigning a first thread to the first processor core or to the second processor core based on the first data and the second data.

11. The method of claim 10, wherein the first data is received in response to a request from a processor core scheduler and the second data is received in response to a request from the processor core scheduler.

12. The method of claim 10, wherein the first circuit comprises a first ring oscillator circuit and the second circuit comprises a second ring oscillator circuit.

13. The method of claim 12, wherein a location of first ring oscillator within the first processor core is based on die area, power, and accessibility and a location of the second ring oscillator within the second processor core is based on die area, power, and accessibility.

14. The method of claim 10, wherein the first data is associated with an oscillation frequency of the first circuit and the second data is associated an oscillation frequency of the second circuit.

15. The method of claim 14, wherein a first frequency difference comprises the difference between a first initial frequency and the oscillation frequency of the first circuit and a second frequency difference comprises the difference between a second initial frequency and the oscillation frequency of the second circuit.

16. The method of claim 14, wherein the first data comprises a first frequency difference between an initial frequency measurement and the oscillation frequency of the first circuit and wherein the second data comprises a second frequency difference between an initial frequency measurement and the oscillation frequency of the second circuit.

17. The method of claim 16, wherein the first thread is assigned to the first processor core if a processor core scheduler determines that the first data has less of a frequency difference than the second data.

18. A system comprising:
a double data rate memory module
a database;
a first processor core comprising a first circuit to generate a first data;
a second processor core comprising a second circuit to generate a second data; and
a processor core scheduler to assign a first thread to the first processor core or to the second processor core based on the first data and the second data.

19. The system of claim 18, wherein the first data is associated with an oscillation frequency of the first circuit and the second data is associated an oscillation frequency of the second circuit.

20. The system of claim 19, wherein the first data comprises a first frequency difference between an initial frequency measurement and the oscillation frequency of the first circuit and wherein the second data comprises a second frequency difference between an initial frequency measurement and the oscillation frequency of the second circuit.

21. The system of claim 20, wherein the processor core scheduler is to assign the thread to the first processor core if the first frequency difference is less than the second frequency difference.

22. The system of claim 18, wherein the first processor core and the second processor core are disposed within a same die.
